(19) United States
(12) Patent Application Publication
(10) Pub. No.: US 2017/0099983 A1
(43) Pub. Date: Apr. 13, 2017

(54) Single Reservoir Beverage Maker

(71) Applicant: Hamilton Beach Brands, Inc., Glen Allen, VA (US)

(72) Inventors: Adam Hanes, Glen Allen, VA (US); Patrick T Mulvaney, Richmond, VA (US)

(73) Assignee: Hamilton Beach Brands, Inc., Glen Allen, VA (US)

(21) Appl. No.: 15/182,195

(22) Filed: Jun. 14, 2016

Related U.S. Application Data
(60) Provisional application No. 62/238,484, filed on Oct. 7, 2015.
(60) Provisional application No. 62/278,744, filed on Jan. 14, 2016.

(51) Int. Cl. A47J 31/56; A47J 31/46

(52) U.S. Cl. CPC A47J 31/56; A47J 31/465

(57) ABSTRACT

A beverage maker includes a reservoir having a first inlet port for receiving liquid for preparing a beverage and a first outlet port for discharging the liquid from the reservoir to a brew chamber. A hot liquid generator (HLG) inlet is in fluid communication with a reservoir second outlet port and an HLG outlet is in fluid communication with a reservoir second inlet. A valve fluidly communicates with the reservoir, the valve being normally in an open position, permitting flow therethrough, and moveable into a closed position, preventing flow therethrough. Liquid flows into the HLG via the reservoir second outlet. HLG powering increases the temperature of the liquid therein and effectuates movement of the liquid back to the reservoir via the HLG outlet. Liquid is continuously recirculated between the reservoir and the HLG, without exiting from the reservoir first outlet port, at least until the valve is closed.

### CROSS REFERENCE TO RELATED APPLICATIONS

This application claims priority to U.S. Provisional Patent Application No. 62/238,484, filed on Oct. 7, 2015, entitled “Single Vessel Beverage Maker,” and U.S. Provisional Patent Application No. 62/278,744, filed on Jan. 14, 2016, entitled “Single Reservoir Beverage Maker,” the entire contents of each of which are incorporated by reference herein.

### BACKGROUND OF THE DISCLOSURE

The present disclosure is generally directed to a beverage maker, and more particularly, to a steam operated single reservoir beverage maker.

Some hot beverage, single-serve makers, whether steam or pump operated, employ a two reservoir system. The receiving reservoir receives a volume of liquid at room temperature. The liquid exits the receiving reservoir, is gradually heated in a heater and thereafter enters into a dispensing reservoir where the liquid resides until dispensing thereof through foodstuff grounds for brewing the beverage.

One drawback of the liquid residing in the dispensing reservoir is that the dispensing reservoir may at least initially absorb heat from the heated liquid. For example, when brewing a first cup of the beverage, e.g., early in the morning, the dispensing reservoir may initially be at room temperature, and, therefore, absorbs a lot of the heat of the heated liquid prior to dispensing thereof. Accordingly, temperature is at least initially lost to the dispensing reservoir, and at least a first volume of the liquid, e.g., approximately 2 to 3 ounces, is below the desired brewing temperature. The affect of such cooling of an initial volume of the liquid is exacerbated when the desired beverage is of a smaller serving size, i.e., resulting in a lukewarm beverage.

Therefore, it would be advantageous to manufacture a single reservoir beverage maker, which recirculates the liquid between the heater and the single reservoir until the entire bulk liquid temperature substantially reaches the optimal brewing temperature, prior to dispensing of the liquid. Thus, any liquid initially cooled by the reservoir is reheated before dispensing occurs, resulting in a more consistent temperature of the brewed beverage.

### BRIEF SUMMARY OF THE DISCLOSURE

Briefly stated, one aspect of the present disclosure is directed to a beverage maker. The beverage maker includes a reservoir having a first inlet port for receiving a volume of liquid to be used for preparing a beverage and a first outlet port for discharging the liquid from the reservoir to a brew chamber to prepare the beverage. A hot liquid generator (HLG) has an HLG inlet in fluid communication with a second outlet port of the reservoir and an HLG outlet in fluid communication with a second inlet port of the reservoir and a passageway extending therebetween. A vent valve is in fluid communication with the reservoir. The vent valve is biased open, permitting gas flow therethrough, and is configured to close when gas exiting the reservoir through the vent valve reaches a threshold flow rate.

Liquid within the reservoir flows into the HLG passageway via the reservoir second outlet port and the HLG inlet. Powering of the HLG increases a temperature of at least a portion of the liquid within the HLG passageway and effectuates movement of the liquid in the HLG passageway back to the reservoir via the HLG outlet and the reservoir second inlet port. Liquid is continuously recirculated between the reservoir and the HLG, without exiting from the reservoir first outlet port, at least until the vent valve is closed.

Another aspect of the present disclosure is directed to a beverage maker comprising a reservoir having a first inlet port for receiving a volume of liquid to be used for preparing a beverage and a first outlet port for discharging the liquid from the reservoir to a brew chamber to prepare the beverage. The reservoir defines a minimum fill level corresponding to a volume of liquid within the reservoir required to prepare a minimum serving of the beverage. The reservoir first outlet port includes a discharge tube extending into the reservoir, an inlet of the discharge tube being positioned at an elevation within the reservoir corresponding to an elevation of approximately 5 mL to approximately 10 mL of liquid within the reservoir. A hot liquid generator (HLG) has an HLG inlet in fluid communication with a second outlet port of the reservoir and an HLG outlet in fluid communication with a second inlet port of the reservoir and a passageway extending therebetween. The reservoir second inlet port includes a second inlet port tube extending into the reservoir, with an outlet of the second inlet port tube being positioned at a lower elevation within the reservoir than the minimum fill level of the liquid.

A vent valve is in fluid communication with the reservoir, the vent valve being biased open, permitting gas flow therethrough, and configured to close when gas exiting the reservoir through the vent valve reaches a threshold flow rate. A pressure relief valve is in fluid communication with the reservoir and is biased closed, and is configured to open when pressure within the reservoir reaches a predetermined value. Liquid within the reservoir flows into the HLG passageway via the reservoir second outlet port and the HLG inlet, and powering of the HLG increases a temperature of at least a portion of the liquid within the HLG passageway and effectuates movement of the liquid in the HLG passageway back to the reservoir via the HLG outlet and the reservoir second inlet port. Liquid is continuously recirculated between the reservoir and the HLG, without exiting from the reservoir first outlet port, at least until the vent valve is closed.

Yet another aspect of the present disclosure is directed to a beverage maker comprising a reservoir having a first inlet port for receiving a volume of liquid to be used for preparing a beverage and a first outlet port for discharging the liquid from the reservoir to a brew chamber to prepare the beverage. A hot liquid generator (HLG) having an HLG inlet is in fluid communication with a second outlet port of the reservoir and an HLG outlet is in fluid communication with a second inlet port of the reservoir and a passageway extends therebetween. A valve is in fluid communication with the reservoir and is normally in an open position, permitting gas flow therethrough. The valve is moveable into a closed position, preventing gas flow therethrough.

Liquid within the reservoir flows into the HLG passageway via the reservoir second outlet port and the HLG inlet, and powering of the HLG increases a temperature of at least a portion of the liquid within the HLG passageway and effectuates movement of the liquid in the HLG passageway back to the reservoir via the HLG outlet and the reservoir second inlet port. Liquid is continuously recirculated between the reservoir and the HLG, without exiting from the reservoir first outlet port, at least until the valve is closed.

### BRIEF DESCRIPTION OF THE DRAWINGS

The foregoing summary, as well as the following detailed description of the disclosure, will be better understood when read in conjunction with the appended drawings. For the purpose of illustrating the disclosure, there is shown in the drawings preferred embodiments of a beverage maker which are presently preferred. It should be understood, however, that the disclosure is not limited to the precise arrangements and instrumentalities shown. In the drawings:

FIG. 1 is a top, front perspective view of a beverage maker according to a preferred embodiment of the disclosure;

FIG. 2 is a schematic block diagram of one embodiment of certain internal components of the beverage maker of FIG. 1;

FIG. 3 is a partial cross-sectional right side elevational view of the beverage maker of FIG. 1, taken along sectional line 3-3 of FIG. 1;

FIG. 4 is a partial cross-sectional left side elevational view of the beverage maker of FIG. 1, taken along sectional line 4-4 of FIG. 1;

FIG. 5 is a partial cross-sectional right side elevational view of another embodiment of the beverage maker of FIG. 1, taken along sectional line 3-3 of FIG. 1;

FIG. 6 is a schematic block diagram of the embodiment of the beverage maker shown in FIG. 5; and

FIG. 7 is a sectional view of an alternative embodiment of a pressure monitor of the embodiment shown in FIG. 5.

### DETAILED DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the beverage maker, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

It should also be understood that the terms “about,” “approximately,” “generally,” “substantially” and like terms, used herein when referring to a dimension or characteristic of a component of the disclosure, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

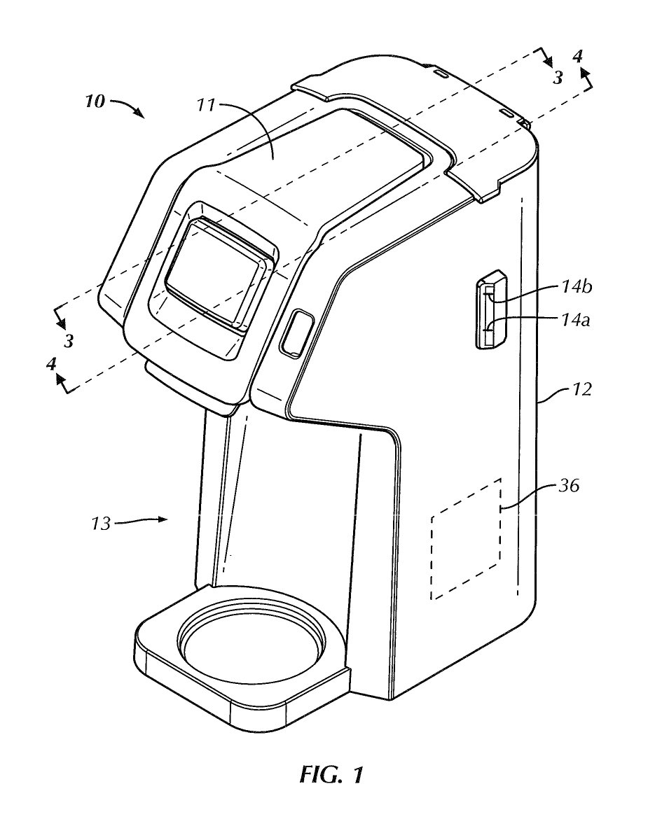

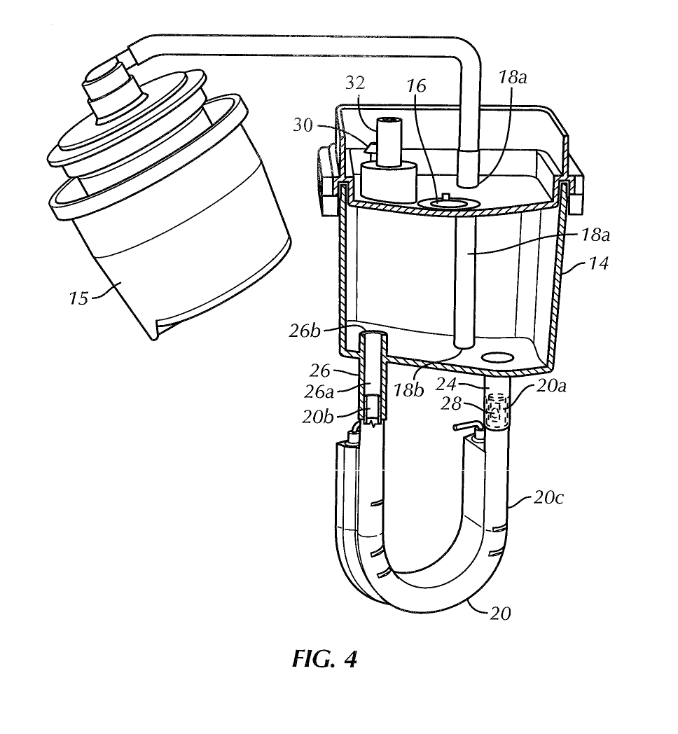

Referring to the drawings in detail, wherein like numerals indicate like elements throughout, there is shown in FIGS. 1-4 a beverage maker, generally designated 10, in accordance with a preferred embodiment of the present disclosure. The beverage maker 10 is intended or designed for preparing a beverage from foodstuff (not shown) to be consumed by a user. The foodstuff is preferably inserted into at least a portion of the beverage maker 10 in a dry or generally dry state. Following completion of preparation of the beverage, any moist or saturated foodstuff remaining in the beverage maker 10 is preferably removed and either recycled or discarded.

Although the beverage maker 10 may be generally referred to as a “coffeemaker,” wherein coffee is prepared from coffee grounds, the beverage maker is preferably capable of making other beverages from extractable/infusible foodstuff as well, such as, for example, without limitation, tea leaves, hot chocolate powder, soup ingredients, oatmeal, and the like. Thus, the beverage maker 10 is versatile because it may be used to create and/or prepare any one of a variety of different types of beverages from a variety of different types of foodstuff. More specifically, the beverage maker 10 preferably heats a liquid, such as water, to a sufficient temperature, e.g., between approximately 90° C. to approximately 99° C., to be combined with or poured over the foodstuff to create a hot beverage (or even a cold beverage if poured over ice).

The beverage maker 10 of the preferred embodiment prepares a beverage of a single-serving size (which is up to approximately sixteen ounces of prepared beverage), although it is envisioned that, in alternative embodiments, the beverage maker 10 may be operative with smaller or larger serving sizes (e.g., a pot or carafe) as well. Depressing an on/off button (not shown) of the beverage maker 10 preferably initiates an operating cycle, and subsequent depressing of the on/off button preferably ends the operating cycle. The phrase “operating cycle” is broadly defined herein as a period of time when the beverage maker 10 is first activated to when the beverage is fully prepared and the beverage maker 10 is deactivated either by itself or by a user depressing the on/off button. As should be understood, the beverage maker 10 is not limited to including solely an on/off button. For example, additional buttons, knobs, switches, levers (not shown) and/or a control panel may be added to the beverage maker 10 to allow the user increased control over the functionality and/or operation of the beverage maker 10.

Referring to FIG. 1, the beverage maker 10 includes a housing or body 12 for enclosing and protecting internal components thereof, as described in further detail below. The body 12 and/or any components thereof may be constructed from any polymer, metal or other suitable material or combinations of materials. For example, an injection molded acrylonitrile butadiene styrene (ABS) material could be employed, but the body 12 may be constructed of nearly any generally rigid material that is able to take on the general shape of the body 12 and perform the functionality of the body 12 described herein. The body 12 may be generally, completely or partially opaque, translucent or transparent. As should be understood, the body 12 includes a recess 13 that is sized, shaped and/or configured to receive and/or support at least a portion of a cup, pot, carafe, travel mug, vessel or other receptacle (not shown) for receiving a beverage that exits the beverage maker 10. The beverage preferably flows, drips or otherwise accumulates in the receptacle, which is subsequently removed from the recess by a user for consumption of the beverage.

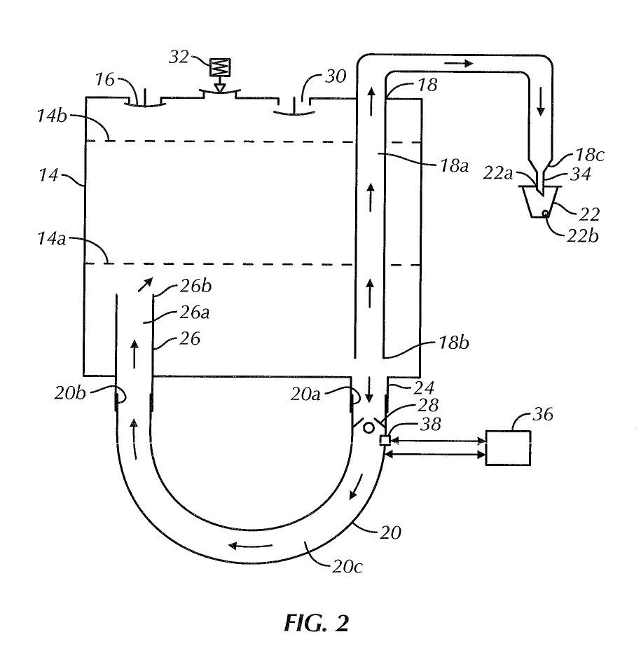

The beverage maker 10 preferably allows a user to create a beverage from foodstuff in any one of a variety of different forms or states. For example, the beverage maker 10 may be used to make a hot beverage from loose grounds or leaves. In the illustrated embodiment, the beverage maker 10 may be used to make a beverage from grounds or leaves packed in a generally soft packet (i.e., a flexible “pod” or a bag), or grounds or leaves packed in a generally hard container/cartridge 22 (shown schematically in FIG. 2), which comprises a brew chamber. The cartridge 22 may include a generally rigid body and a cap or foil top removable therefrom. For example, the cartridge 22 may be a conventional K-CUP®, a rigid pod, or any other structure that is capable of holding or storing foodstuff.

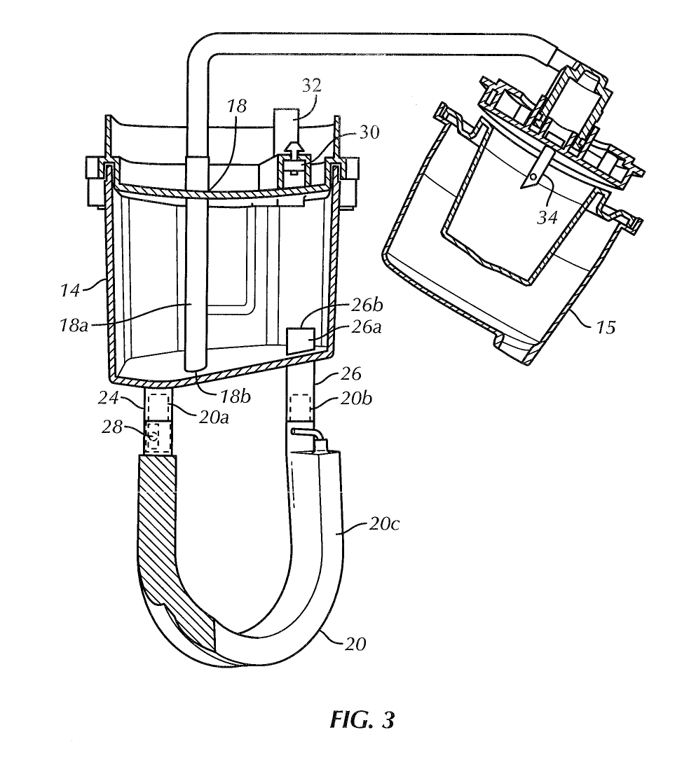

Additionally or alternatively, the brew chamber may include a funnel 15 (shown in FIG. 3) oriented above the recess, through which a beverage is dispensed. The funnel 15 may include a basket (not shown) receiving loose foodstuff grounds or the like. As also should be understood, the funnel 15 may be configured to accommodate either the basket or the cartridge 22, such that a user may select whether to utilize loose grounds with the basket or grounds contained within a cartridge 22.

FIG. 2 is a schematic block diagram of various internal components of the beverage maker 10 to illustrate the flow of fluid therethrough. As shown schematically in FIG. 2, the beverage maker 10 includes a single reservoir 14. The term “reservoir” is broadly used herein as a body, cavity, or conduit that holds a volume of liquid, either temporarily or for an extended period of time. The reservoir 14 is preferably sized, shaped and/or configured to receive at least an amount of liquid that is suitable for at least a single-serving size. Generally, a minimum serving size is approximately 8 oz. (approximately 236.5 mL) of beverage and a maximum serving size is approximately 14 oz. (approximately 414 mL) of beverage.

Referring to FIG. 2, the reservoir 14 includes a minimum fill level indicator 14a positioned at an elevation within the reservoir 14 corresponding to the elevation associated approximately with the minimum serving size and may include a maximum fill level line indicator 14b positioned at an elevation within the reservoir 14 corresponding to the elevation associated approximately with the maximum serving size. As should be understood by those of ordinary skill in the art, however, the reservoir 14 may alternatively be sufficiently sized to receive an amount of liquid that is capable of filling an entire carafe of approximately one liter or greater, for example. As also should be understood by those of ordinary skill in the art, the reservoir 14 may alternatively be removably attached to the interior or exterior of the body 12. As shown in FIG. 1, the fill level indicators 14a and 14b of the reservoir 14 are visible to a user from outside the body 12.

The reservoir 14 includes a first inlet port 16, i.e., a fill port, for receiving a volume of liquid, e.g., water, to be used or preparing the beverage. In the illustrated embodiment, the fill port 16 takes the form of an inlet check valve. As should be understood by those of ordinary skill in the art, any check valve described herein, may be any type of one-way valve, such as a silicone flapper valve, a ball-type valve, a diaphragm-type valve, a duckbill valve, an in-line valve, a stop-check valve, a lift-check valve, or the like. Alternatively, however, the fill port 16 may take the form of a lid or cover 11 movably, e.g., hingedly or otherwise pivotably, attached to the body 12 or the reservoir 14. The lid 11 is movable between an open position to provide and allow access to the interior of the reservoir 14, and a closed position, closing the body 12 or reservoir 14.

The reservoir 14 further includes a first outlet port 18 formed in an upper end of the reservoir 14 for discharging liquid from the reservoir 14 to the brew chamber 22. As shown in FIGS. 2-4, the first outlet port 18 comprises a first outlet port tube 18a, i.e., riser tube, extending from inside the reservoir 14 to a discharge port 34 attached to the movable cover 11 and movable therewith. In a preferred embodiment, the inlet 18b of the first outlet port tube 18a is positioned at an elevation within the reservoir 14 corresponding to the elevation associated with approximately 5 mL to approximately 10 mL of liquid within the reservoir 14, as will also be described further below. A portion of an outlet end 18c of the first outlet port tube 18a may be slanted or sloped to direct liquid toward the discharge port 34.

In the illustrated embodiment, a lower tip of the discharge port 34 may be sharp or pointed for piercing a cartridge 22 when present. Thus, in embodiments where a cartridge 22 is used, an interior of the cartridge 22 is fluidly connected to the discharge port 34, and, therefore, to the first outlet port 18. The motion of closing the cover 11 brings the pointed end of the discharge port 34 into contact with the top or cap of the cartridge 22, such that the tip or distal end of the discharge port 34 at least partially pierces or is otherwise inserted into or through the cap of the cartridge 22.

As should be understood, prior to being inserted into the beverage maker 10, the cartridge 22 may be air-tight. However, once the cartridge 22 is properly inserted into the beverage maker 10 and the cover 11 is closed, at least two spaced-apart holes are preferably formed or present in the cartridge 22. A first hole 22a exists by or at the discharge port 34 piercing or being inserted into the cartridge cap. A second hole 22b is present or is formed preferably in or near a lower end of the cartridge 22 and vertically below foodstuff grounds within the cartridge 22. The second hole 22b can be formed during and/or after the cartridge 22 is properly inserted into the beverage maker 10. The second hole 22b allows the infused beverage to exit the cartridge 22 for dispensing into a receptacle. As should be understood by those of ordinary skill in the art, however, the discharge port 34 may alternatively resemble a more conventional showerhead of an automatic drip coffeemaker (ADC) for use with loose infusible material in the funnel 15.

As shown in FIGS. 2-4, the beverage maker 10 further includes at least one hot liquid generator (HLG) 20. The HLG 20 is preferably capable of heating liquid therein to at least a temperature sufficient to create a phase change of at least some of the liquid therein into gas, e.g., steam. Such a phase change creates or generates the force(s) necessary to move fluid throughout the beverage maker 10 to prepare the beverage. In the illustrated embodiment, the HLG 20 is preferably a generally U-shaped, tubular, aluminum extrusion, HLG with a cal-rod. Such a device is a generally inexpensive means to heat and motivate liquid in a non-mechanical manner (i.e., without impellers, an air pump, or the like). However, as should be understood by those of ordinary skill in the art, other hot liquid generators, currently known or that later become known, may alternatively be utilized. For example, without limitation, the HLG 20 may take the form of a boiler or the like having a heater to heat the liquid therein, which is in direct or indirect physical contact with the liquid.

An inlet end 20a (i.e., upstream side) of the HLG 20 is in fluid communication with a second outlet port 24 of the reservoir 14 and an outlet end 20b (i.e., downstream side) of the HLG 20 is in fluid communication with a second inlet port 26 of the reservoir 14 comprising a second inlet port tube 26a extending into the reservoir 14. A passageway 20c of the HLG 20 extends therebetween. The phrase “fluid connection” is broadly defined herein as being in fluid communication, in addition to being “adjacent to” by direct or indirect attachment. In the illustrated embodiment, both the second outlet port 24 and the second inlet port 26 of the reservoir 14 are positioned in a base end of the reservoir 14. At least a portion of a bottom wall of the reservoir 14 may be slanted or sloped as shown in FIG. 2 to direct liquid within the reservoir 14 toward the second outlet port 24.

In one embodiment, a 600 Watt HLG 20 is utilized to heat the liquid within the HLG passageway 20c and also generate steam. In a preferred embodiment, however, an approximately 900 Watt to 1100 Watt HLG is employed, in order to heat the liquid faster. Operation, i.e., energizing, of the HLG 20 is controlled via a controller 36. The controller 36 may be any type of controller, such as a microprocessor, multiple processors, or the like. The controller 36 preferably includes or is operatively coupled to a memory (not shown) that stores the code or software for carrying out operation of the beverage maker 10, including the HLG 20. The memory can be any known or suitable memory device such as read only memory (ROM) or the like. As should be understood, the controller 36 may also include, as hardware or software, or may be operatively connected to other components, such as clocks, timers, or the like (not shown) used for operating the beverage maker 10. As will be described in further detail below, the controller 36 controls operation of the HLG 20 in a manner which safeguards against excessive steam generation, which may otherwise damage the cartridge 22.

As shown in FIGS. 2-4, an inlet check valve 28 is positioned proximate to the second outlet port 24 of the reservoir 14 and the HLG inlet 20a. Liquid flows from the reservoir 14 to the HLG 20, e.g., under the force of gravity, through the inlet check valve 28. The inlet check valve 28 prevents liquid from flowing back out of the HLG inlet 20a into reservoir 14 via the second outlet port 24.

The beverage maker 10 further includes a vent valve 30 in fluid communication with the reservoir 14. The vent valve 30 is normally biased into an open position, in a manner well understood by those of ordinary skill in the art, to allow gas to escape from the reservoir 14 therethrough as liquid is received into the reservoir 14. The vent valve 30 also permits steam vapor to escape from the reservoir 14 therethrough during a brewing cycle involving heating of the liquid, as will be described in further detail below.

The vent valve 30 is movable into a closed position, against the biasing force normally maintaining the vent valve 30 in the open position, when gas, e.g., steam vapor, exiting the reservoir 14 therethrough reaches a threshold flow rate. That is, and as should be understood by those of ordinary skill in the art, as steam accumulates within the reservoir 14, the pressure differential between the (greater) pressure inside the reservoir 14 relative to the (lower) pressure external to the reservoir 14, i.e., the pressure across the vent valve 30, overwhelms and closes the vent valve 30. Once the vent valve 30 is closed, the valve 30 remains closed due to the static air pressure. As should be understood, the location and size of the vent valve 30 factors into determining the threshold gas flow rate therethrough required to overwhelm and move the vent valve 30 into the closed position. The diameter of the vent valve 30 is particularly set to balance between sufficiently allowing air to escape therethrough during filling of the reservoir 14 (when the valve 30 is open) and thereafter assisting in building pressure within the reservoir 14 for dispensing the liquid therefrom (when the valve 30 is closed).

In one embodiment, as described above, the vent valve 30 is a steam operated valve, such as, for example, without a limitation, a needle valve or the like, although other types of valves, currently known or that later become known, may be implemented. Alternatively, the vent valve 30 may take the form of an electronically operated solenoid valve, opened and closed in response to electronic signals from the controller 36 according to feedback received by the controller 36.

Referring to FIG. 2, the beverage maker 10 further includes a pressure relief valve 32, which is preferably in the form of a spring biased needle valve or the like, in fluid communication with the reservoir 14. Conversely to the vent valve 30, the pressure relief valve 32 is biased into a normally closed position under normal operating conditions and is configured to move against the bias force into an open position at a predetermined internal pressure of the reservoir 14, determined to be an abnormally high amount of pressure, e.g., greater than approximately 2 psi. In the event that an abnormally high amount of pressure builds up in the reservoir 12, the pressure relief valve 32 opens, permitting gas, e.g., steam, to escape through the pressure relief valve 32 to relieve the excessive pressure.

In general operation, the beverage maker 10 is first powered on, e.g., when the beverage maker 10 is plugged into an outlet, recovers from a power failure, or the like. At power on, the controller 36 enters into communication with at least the HLG 20. To make a beverage, a user opens the cover to access the reservoir 14 and pour liquid, e.g., water, through the first inlet port 16, and inserts a cartridge 22 into the proper location. As should be understood, liquid flows into the HLG passageway 20c via the reservoir second outlet port 24 and the HLG inlet 20a (through the check valve 28) under gravitational force. Once the user pours in the desired volume of liquid, the user closes the cover and initiates the brewing cycle, e.g., by selecting a button or combination of buttons. The controller 36 thereafter energizes the HLG 20.

Powering of the HLG 20 via the controller 36 increases the temperature of at least a portion of the liquid within the HLG passageway 20c to a temperature sufficient to create a phase change of at least some of the liquid into gas. The phase change generates force, e.g., steam vapor flow, which effectuates movement of the remaining liquid in the HLG passageway 20c back to the reservoir 14 via the HLG outlet 20b and the reservoir second inlet port 26, as the check valve 28 prevents movement in the reverse direction. Liquid and steam vapor within the HLG passageway 20c that enter back into the reservoir 14, via the HLG outlet 20b and second inlet port 26, because of the steam vapor flow, are continuously replaced by liquid within the reservoir 14 that enters into the HLG passageway 20c, via the second outlet port 24 and the HLG inlet 20a, under the force of gravity. Therefore, the liquid is continuously recirculated between the reservoir 14 and the HLG 20 in a heating loop.

With each loop of recirculated liquid through the HLG 20 the bulk temperature of the liquid within the reservoir 14 increases. Accordingly, with each recirculation cycle, liquid enters the HLG 20 at a greater starting temperature, and, therefore, a greater percentage of the liquid within the HLG 20 transitions from liquid to gas. Consequently, with each recirculation cycle, a greater volume of steam vapor enters back into the reservoir 14 via the reservoir second inlet port 26, and exits the reservoir 14 through the open vent valve 30. Thus, steam flow continuously increases across, i.e., through, the vent valve 30. Once the vent valve 30 can no longer accommodate the entire steam flow rate therethrough, thereby restricting the steam flow rate therethrough, a pressure differential builds across the vent valve 30 and ultimately overwhelms and moves the vent valve 30 into the closed position.

Once the vent valve 30 closes (and the pressure relief valve 32 is also normally closed), additional steam generated in the HLG 20 enters the reservoir 14, accumulates within the reservoir 14 and pressurizes the reservoir 14, i.e., creates a pressure differential across the first outlet port 18 (the only remaining open outlet). Because the inlet 18b of the first outlet port tube 18a is positioned at an elevation within the reservoir 14 corresponding to the elevation associated with approximately 5 mL to approximately 10 mL of liquid within the reservoir 14, and as the minimum volume of liquid within the reservoir 14 to brew the minimum serving size is greater than 10 mL, the liquid level within the reservoir 14 exceeds the elevational position of the inlet 18b of the first outlet port tube 18a, i.e., the inlet 18b is submerged in the liquid, for the majority of the brewing cycle. As should be understood, heating of the liquid within the reservoir 14 causes expansion of the liquid, that, in turn, causes the liquid level to rise in the first outlet port tube 18a. Ultimately, as the reservoir 14 becomes increasingly pressurized, the heated liquid is driven out of the reservoir 14 through the first outlet port tube 18a, exiting through the discharge port 34 to interact with the foodstuff grounds in the cartridge 22.

As some liquid exits the reservoir 14 through the first outlet port tube 18a, other liquid within the reservoir 14 simultaneously continues to recirculate through the HLG 20, thereby continuing the generation of steam within the reservoir 14 to continue driving liquid out of the reservoir 14 through the first outlet port tube 18a. Finally, when the remaining liquid within the reservoir 14 is down to the last 5 mL to 10 mL, and, therefore, the inlet 18b of the first outlet port tube 18a is no longer submerged in liquid, the last 5 mL to 10 mL of liquid are converted substantially entirely to steam within the HLG 20 and the steam exits the reservoir 14 through the first outlet port tube 18a to dry out the system at the end of the brewing cycle.

Where a cartridge 22 packing foodstuff grounds is utilized, the cartridge 22 remains at least relatively or even fully air-tight, thereby acting as a restriction on the discharge port 34. To overcome this restriction, the heated liquid flows under pressure through the discharge port 34 and into the cartridge 22 to saturate the foodstuff therein. The heated liquid is therefore forced to flow through the saturated foodstuff under pressure and exits the cartridge 22 through aperture 22b. By pressurizing the heated liquid within the cartridge 22, the liquid wicks better with the grounds to create a stronger hot beverage, and the brewed beverage is dispensed at a faster flow rate.

As should be understood by those of ordinary skill in the art, the ideal bulk temperature of the liquid within the reservoir 14 prior to exiting the reservoir 14 to the discharge port 34 is between approximately 90° C. and approximately 100° C. for optimal wicking with the foodstuff grounds within the cartridge 22. One challenge associated with the aforementioned operation of the beverage maker 10 is that all of the steam vapor generated within the HLG 20 exits through the vent valve 30 (or through the pressure relief valve 32 if the pressure within the reservoir 14 exceeds approximately 2 psi after the vent valve 30 closes), leading to excessive loss of water in the form of steam vapor and excessive loss of heat. Further, the steam generated in the HLG may prematurely overwhelm the vent valve 30, resulting in premature expulsion of the liquid from the reservoir 14 to the cartridge 22, i.e., expulsion of the liquid while still at a lukewarm temperature less than approximately 90° C.

Therefore, as shown schematically in FIG. 2, the outlet 26b of the second inlet port tube 26a is positioned at a lower elevation within the reservoir 14 than the minimum fill level 14a of the liquid within the reservoir 14. By positioning the outlet 26b below the minimum fill level 14a, i.e., the outlet 26b being submerged in the liquid within the reservoir 14, steam vapor, i.e., gas bubbles, exiting the second inlet port tube 26a from the HLG 20 and entering back into the reservoir 14 must flow through the liquid prior to reaching the vent valve 30 or the pressure relief valve 32.

One significant advantage of steam flow through the liquid is that the steam vapor transfers heat to the surrounding liquid as the vapor flows toward the vent valve 30 or the pressure relief valve 32, in a manner well understood by those of ordinary skill in the art, thereby assisting in the heating the liquid within the reservoir 14. Another significant advantage of such flow of steam vapor bubbles through the liquid within reservoir 14 prior to exiting the reservoir is that the heat transfer from the steam vapor bubbles to the liquid results in a reduction in steam bubble volume and the liquid decelerates the escape of the steam vapor from the reservoir 14, in a manner well understood by those of ordinary skill in the art. Therefore, advantageously, a smaller vent valve 30 may be implemented to minimize the volume of steam exiting the reservoir 14 while also being balanced to remain open until the liquid within the reservoir 14 substantially reaches the desirable bulk liquid temperature, prior to exiting the reservoir 14.

Another advantage of the aforementioned operation of the single reservoir beverage maker 10 is that the liquid does not exit the single reservoir 14 to the discharge port 34 until after the vent valve 30 is closed, and, hence, the bulk temperature of the liquid within the reservoir 14 has reached the desired temperature. Thereafter, once the liquid within the reservoir 14 begins to exit through the first outlet port tube 18a, this dispensing portion of the brewing cycle is a substantially continuous process. The steam generation within the reservoir 14 continues, as described above, and, therefore, the pressure and flow rate of the dispensed liquid are more consistent than a two reservoir beverage maker, and the stream of brewed beverage from the cartridge 22 is generally continuous.

With respect to operation of the HLG 20, the controller 36 is configured to cyclically supply power to, and shut off the power to, the HLG 20, and/or adjust the power supplied to the HLG 20 to balance heating of the liquid and generating steam without generating an excessive amount of steam to overwhelm the vent valve 30 or cause the pressure relief valve 32 to be opened. For example, the controller 36 may be configured to energize the HLG 20 to initially rapidly heat the liquid within the reservoir 14 to the desired bulk temperature, and, thereafter, reduce or eliminate the power to the HLG 20 to minimize excessive steam generation when the liquid approaches the desired bulk temperature within the reservoir 14 and is ready for dispensing. With power to the HLG 20 reduced, or cyclically supplied and shut off, the HLG 20 will generally generate and maintain only the appropriate volume of steam required to dispense the liquid out of the reservoir 14 to the discharge port 34.

As should be understood by those of ordinary skill in the art, any of numerous methods currently known in the art, or that later become known, to control the steam production of the HLG 20 may be utilized. For example, without limitation, a switching semiconductor (not shown), i.e., a triac, may be operatively connected between the controller 36 and the HLG 20, through which the controller 36 may reduce the current to the HLG 20, thereby reducing the power output of the HLG 20. As another example, without limitation, an HLG 20 having more than one heating element may be employed, each heating element having a respective power output, and the controller 36 may be configured to power or shut power to the appropriate heating element(s) to achieve the desired steam output. As yet another example, without limitation, power to the HLG 20 may be pulsed on and off with a duty cycle. Yet alternatively, a pressure transducer may be utilized to determine whether the vent valve 30 is moved into the closed position, thereby signaling the subsequently following liquid dispensing, to activate a shut off switch connected to the power source to the HLG 20.

In one embodiment, as shown schematically in FIG. 2, a temperature sensor 38 configured to sense the temperature of the liquid within the reservoir 14 is employed and operatively connected to the controller 36, for the controller 36 to determine when the liquid within the reservoir 14 is ready for dispensing. The controller 36 controls the HLG 20 according to feedback received from the temperature sensor 38. Namely, as the HLG 20 heats the liquid within the HLG passageway 20c, the temperature sensor 38 communicates with the controller 36, providing feedback correlating to the bulk temperature of the liquid within the reservoir 14. The controller 36 periodically reads the feedback and calculates the bulk temperature of the liquid within the reservoir 14, in a manner well understood by those of ordinary skill in the art, to assess whether the temperature of the liquid in the reservoir 14 has reached or exceeded a preset final temperature, e.g., within the range of approximately 90° C. to approximately 100° C., associated with dispensing or imminent dispensing of the liquid from the reservoir 14 through the first outlet port tube 18a.

As should be understood, any temperature sensor 38, currently known or that later becomes known by those of ordinary skill in the art may be utilized. For example, without limitation, a thermistor that changes resistance with temperature and transmits a corresponding voltage to the controller 36, a thermostat which is preset to communicate to the controller 36 whether a specific temperature has been reached, or the like, may be employed.

In the illustrated embodiment, the temperature sensor 38 is positioned proximate the HLG inlet 20a, in direct contact with the liquid, to sense whether the liquid is near the boiling point thereof. As also should be understood, however, the temperature sensor 38 may be located elsewhere within the HLG 20 or within the reservoir 14, and configured to directly or indirectly measure the temperature of the liquid, such as, for example, without limitation, in the first outlet port tube 18a. Alternatively, the temperature sensor 38 may be positioned at the exit of the pressure relief valve 32 and configured to detect a steep increase in temperature that would indicate steam release through the pressure relief valve 32, and, therefore, an excessive amount of pressure buildup within the reservoir 14.

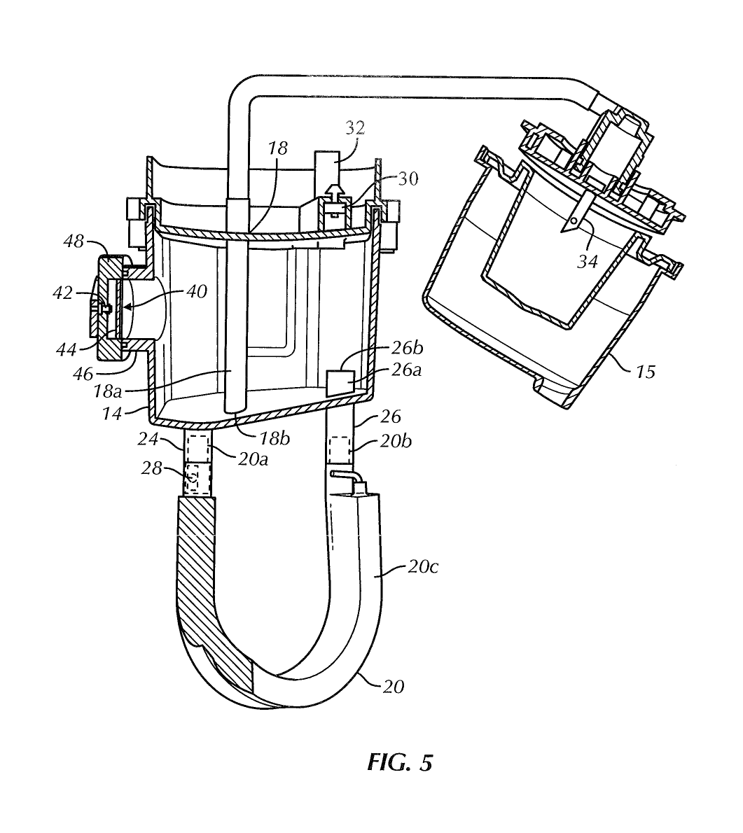

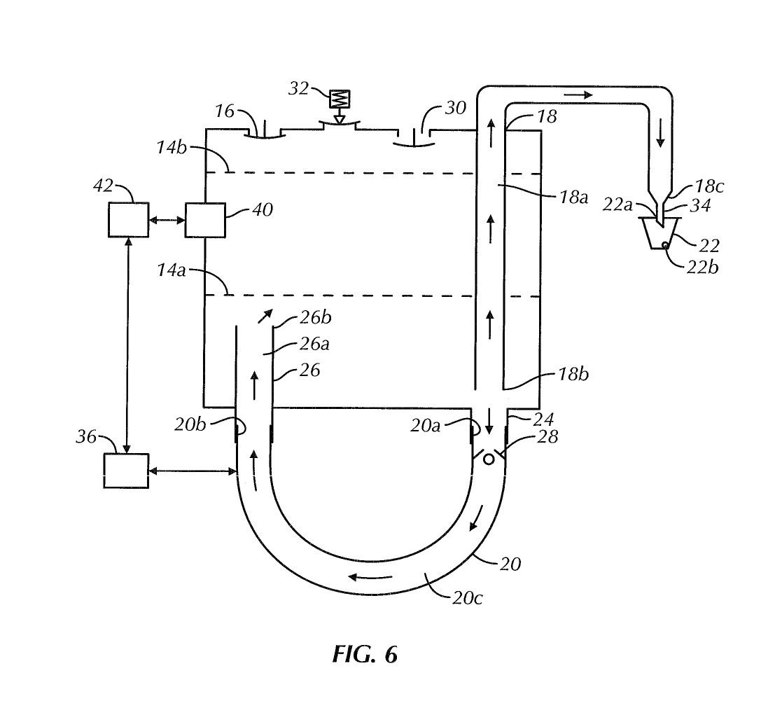

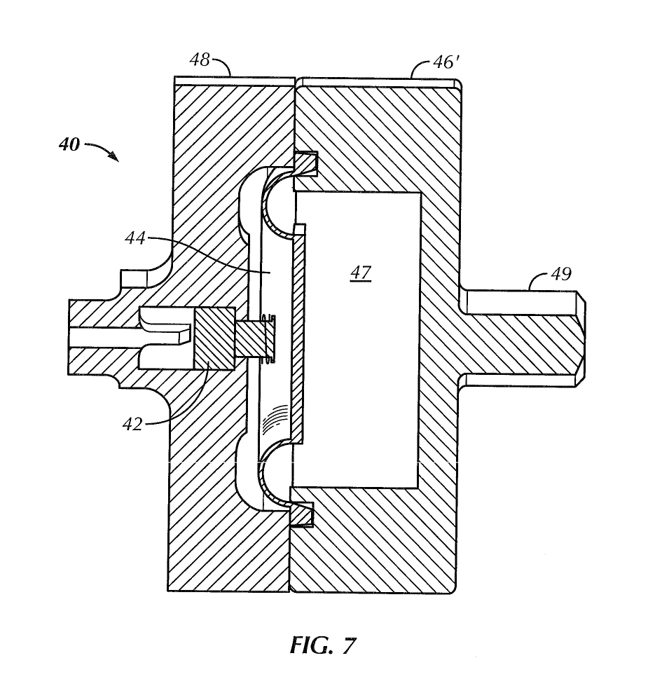

In another embodiment, as shown schematically in FIG. 6, a pressure monitor 40 is in fluid communication with the reservoir 14 for continuously monitoring pressure therein. In the illustrated embodiment of FIG. 5, the pressure monitor is integrated into the reservoir 14, i.e., built into the side wall of the reservoir 14. However, as should be understood by those of ordinary skill in the art, the pressure monitor 40 may be in direct or indirect fluid communication with the reservoir 14 via any of numerous means currently known, or that later become known, capable of performing the function of the pressure monitor 40 as described herein. For example, as shown in FIG. 7, and as will be described in further detail below, the pressure monitor 40 may take the form of an individual, separate component connected to the reservoir 14.

Referring to FIG. 6, a switch 42 is in electrical communication with the controller 36. The controller 36 controls power supplied to the HLG 20 according to communications received from the switch 42. The switch 42 may take the form of any electromechanical microswitch or the like, currently known or that later becomes known, capable of performing the functions of the switch 42 described herein. The switch 42 is actuatable by the pressure monitor 40, between and an “on” configuration (not shown) and an “off” configuration (FIGS. 5 and 7) at a predetermined threshold pressure in the reservoir 14. In the illustrated embodiment, the controller 36 supplies power to the HLG 20 in the off configuration of the switch 42, and the switch 42 electrically communicates with the controller 36 to shut off power to the HLG 20 in the on configuration of the switch 42. The switch 42 is biased into the off configuration in a manner well understood by those of ordinary skill in the art, e.g., spring biased, thus normally permitting the controller 36 to supply power to the HLG 20. The switch 42 is actuated into the on configuration when the pressure monitor 40 determines that the pressure within the reservoir 14 is at or above a predetermined threshold pressure. As should be understood, however, the controller 36 may alternatively supply power to the HLG 20 in the on configuration of the switch 42, the switch 42 being normally biased into the on position and actuatable into the off position by the pressure monitor 40 to communicate with the controller 36 to shut off power to the HLG 20. As also should be understood, the switch 42 may alternatively be in direct electrical communication between a power supply (not shown) and the HLG 20, thereby directly connecting or disconnecting the power supply to the HLG 20.

In the illustrated embodiment, the pressure monitor 40 takes the form of an expandable and contractible diaphragm 44 in fluid communication with the reservoir 14. As should be understood by those of ordinary skill in the art, however, the pressure monitor 40 may alternatively be an electronic pressure sensor, a pressure transducer, or any other pressure sensing, monitoring or reacting means, currently known or that later becomes known, capable of differentiating between pressure above or below the predetermined threshold pressure. As shown in FIG. 5, the diaphragm 44 is clamped between an annular projection 46, projecting from the reservoir 14 sidewall, and a clamping member 48, clamping a periphery of the diaphragm 44 onto the annular projection 46. Alternatively, as shown in FIG. 7, the diaphragm 44 may be clamped into an individual housing 46′ by the clamping member 48. The clamping member 48 clamps the periphery of the diaphragm 44 into the housing 46′ sidewall, and the diaphragm 44 is positioned within a chamber 47 defined by the housing 46′ and the clamping member 48. In such an embodiment, the housing 46′ is connected to the reservoir 14, e.g., via the member 49, to fluidly communicate the diaphragm 44 with the reservoir 14. As should be understood by those of ordinary skill in the art, however, the diaphragm 44 may be secured in fluid communication with the reservoir 14 via any of numerous different means currently known or that later become known.

The diaphragm 44 is progressively expandable with increasing pressure in the reservoir 14 and progressively contractible with decreasing pressure in the reservoir 14. In the illustrated embodiment, the switch 42 is secured to the clamping member 48, and the diaphragm 44 and the switch 42 are spaced relative to one another such that the diaphragm 44 only engages and actuates the switch 42 into the on configuration (causing the switch 42 to electrically communicate to the controller 36 to shut off power to the HLG 20) in an expanded state thereof, substantially corresponding to the pressure within the reservoir 14 having reached the predetermined threshold pressure. The diaphragm 44 contracts when the pressure within the reservoir 14 drops, and, therefore, disengages from the switch 42 when the pressure within the reservoir 14 drops below the predetermined threshold pressure, thereby permitting the switch 42 to return to, or remain in, the off configuration (disconnecting the switch 42 from the controller 36, thereby powering the HLG 20). As should be understood by those of ordinary skill in the art, a margin of error in the expansion of the diaphragm 44 may vary the pressure in the reservoir 14 that results in actuation of the switch 42 by such margin of error.

In operation, as explained previously, the controller 36 energizes the HLG 20 to increase the temperature of the liquid within the reservoir 14 via continuous recirculation between the reservoir 14 and the HLG 20 in a heating loop. As the bulk temperature of the liquid within the reservoir 14 increases with each recirculation cycle, the vent valve 30 is ultimately closed due to the steam flow rate therethrough. Thereafter (and with the pressure relief valve 32 normally closed), additional steam generated in the HLG 20 enters the reservoir 14, accumulates therein and pressurizes the reservoir 14. As the reservoir 14 becomes increasingly pressurized, the heated liquid is driven out of the reservoir 14 through the first outlet port tube 18a, exiting through the discharge port 34 to interact with the foodstuff grounds in the cartridge 22.

The predetermined threshold pressure at which the diaphragm 44 actuates the sensor 42 into the on configuration, thereby communicating to the controller 36 to shut off power to the HLG 20, is selected to be greater than the necessary pressure required within the reservoir 14 to close the vent valve 30 and drive the heated liquid out through the first outlet port tube 18a. Thus, the HLG 20 will not be powered down prematurely. The predetermined threshold pressure may also be selected to be less than the internal pressure of the reservoir 14 at which the pressure relief valve 32 opens, i.e., a pressure determined to be an abnormally high. Thus, the HLG 20 will be powered down prior to creating an abnormally high pressure within the reservoir 14. For example, the predetermined threshold pressure within the reservoir 14 for actuating the switch 42 to power down the HLG 20 may be within the range of approximately 1.0 psi to approximately 2.5 psi. Accordingly, the pressure monitor 40 and the switch 42 permit power-on and power-off modulation of the HLG 20 to increase and, thereafter, maintain the pressure within the reservoir 14 within a range sufficient to heat and drive the heated liquid out of the reservoir 14 through the first outlet port tube 18a, without unduly increasing the pressure within the reservoir 14 to an abnormally high state. Overall, there is recognized herein the manner of controlling the heater in the subject beverage maker to minimize steam.

It will be appreciated by those skilled in the art that changes could be made to the embodiments described above without departing from the broad inventive concept thereof. For example, the beverage maker 10 may include a second reservoir for receiving and/or holding liquid to be used for preparing a beverage that in fluid communication with the reservoir and preferably selectively removable from the body. It is understood, therefore, that this disclosure is not limited to the particular embodiments disclosed, but it is intended to cover modifications within the spirit and scope of the present disclosure as defined by the appended claims.

We claim:

1. A beverage maker comprising:
a reservoir having a first inlet port for receiving a volume of liquid to be used for preparing a beverage and a first outlet port for discharging the liquid from the reservoir to a brew chamber to prepare the beverage;
a hot liquid generator (HLG) having an HLG inlet in fluid communication with a second outlet port of the reservoir and an HLG outlet in fluid communication with a second inlet port of the reservoir and a passageway therebetween; and
a vent valve in fluid communication with the reservoir, the vent valve being biased open, permitting gas flow therethrough, and configured to close when gas exiting the reservoir through the vent valve reaches a threshold flow rate;
wherein liquid within the reservoir flows into the HLG passageway via the reservoir second outlet port and the HLG inlet, and powering of the HLG increases a temperature of at least a portion of the liquid within the HLG passageway and effectuates movement of the liquid in the HLG passageway back to the reservoir via the HLG outlet and the reservoir second inlet port, liquid being continuously recirculated between the reservoir and the HLG, without exiting from the reservoir first outlet port, at least until the vent valve is closed; and
wherein the reservoir defines a minimum fill level corresponding to a volume of liquid within the reservoir required to prepare a minimum serving of the beverage, and wherein the reservoir second inlet port comprises a second inlet port tube extending into the reservoir, an outlet of the second inlet port tube being positioned at a lower elevation within the reservoir than the minimum fill level of the liquid.

2. The beverage maker of claim 1, further comprising a check valve positioned proximate to the reservoir second outlet port and the HLG inlet, the check valve preventing liquid in the HLG passageway from entering into the reservoir from the reservoir second outlet port.

3. The beverage maker of claim 1, wherein the reservoir first outlet port comprises a first outlet port tube extending into the reservoir, an inlet of the first outlet port tube being positioned at an elevation within the reservoir corresponding to an elevation of approximately 5 mL to approximately 10 mL of liquid within the reservoir.

4. The beverage maker of claim 1, wherein the HLG is a U-shaped, tubular, aluminum extrusion with a cal-rod.

5. The beverage maker of claim 1, further comprising a controller configured to at least one of (1) cyclically supply power to, and shut off the power to, the HLG and (2) adjust power supplied to the HLG.

6. The beverage maker of claim 5, further comprising a temperature sensor in operative communication with the controller, for directly or indirectly sensing the temperature of the liquid within the reservoir.

7. The beverage maker of claim 6, wherein the temperature sensor is located proximate the HLG inlet.

8. The beverage maker of claim 5, further comprising a pressure monitor in fluid communication with the reservoir for continuously monitoring pressure therein, and a pressure switch in electrical communication with the controller, the pressure switch being actuatable by the pressure monitor between on and off configurations at a generally, predetermined threshold pressure within the reservoir.

9. The beverage maker of claim 8, wherein the controller supplies power to the HLG in the off configuration of the pressure switch, and the pressure switch electrically communicates with the controller to shut off power to the HLG in the on configuration of the pressure switch.

10. The beverage maker of claim 9, wherein the pressure switch is biased into the off configuration and is actuated into the on configuration when the pressure monitor determines that the pressure within the reservoir is at or above the threshold pressure.

11. The beverage maker of claim 10, wherein the pressure monitor comprises an expandable and contractible diaphragm, the diaphragm being expandable with increasing pressure within the reservoir and contractible with decreasing pressure within the reservoir, the diaphragm being configured to engage and actuate the pressure switch into the on configuration at substantially the threshold pressure within the reservoir and the diaphragm being configured to be disengaged from the pressure switch below the threshold pressure, thereby permitting the pressure switch to return to, or remain in, the off configuration.

12. The beverage maker of claim 1, further comprising a pressure relief valve in fluid communication with the reservoir, the pressure relief valve being biased closed, and configured to open when pressure within the reservoir reaches a predetermined value.

13. A beverage maker comprising:
a reservoir having a first inlet port for receiving a volume of liquid to be used for preparing a beverage and a first outlet port for discharging the liquid from the reservoir to a brew chamber to prepare the beverage, the reservoir defining a minimum fill level corresponding to a volume of liquid within the reservoir required to prepare a minimum serving of the beverage and the reservoir first outlet port including a discharge tube extending into the reservoir, an inlet of the discharge tube being positioned at an elevation within the reservoir corresponding to an elevation of approximately 5 mL to approximately 10 mL of liquid within the reservoir;
a hot liquid generator (HLG) having an HLG inlet in fluid communication with a second outlet port of the reservoir and an HLG outlet in fluid communication with a second inlet port of the reservoir and a passageway therebetween, the reservoir second inlet port including a second inlet port tube extending into the reservoir, an outlet of the second inlet port tube being positioned at a lower elevation within the reservoir than the minimum fill level of the liquid;
a vent valve in fluid communication with the reservoir, the vent valve being biased open, permitting gas flow therethrough, and configured to close when gas exiting the reservoir through the vent valve reaches a threshold flow rate; and
a pressure relief valve in fluid communication with the reservoir, the pressure relief valve being biased closed, and configured to open when pressure within the reservoir reaches a predetermined value;
wherein liquid within the reservoir flows into the HLG passageway via the reservoir second outlet port and the HLG inlet, and powering of the HLG increases a temperature of at least a portion of the liquid within the HLG passageway and effectuates movement of the liquid in the HLG passageway back to the reservoir via the HLG outlet and the reservoir second inlet port, liquid being continuously recirculated between the reservoir and the HLG, without exiting from the reservoir first outlet port, at least until the vent valve is closed.

14. The beverage maker of claim 13, further comprising a check valve positioned proximate to the reservoir second outlet port and the HLG inlet, the check valve preventing liquid in the HLG passageway from entering into the reservoir from the reservoir second outlet port.

15. The beverage maker of claim 13, wherein the HLG is a U-shaped, tubular, aluminum extrusion with a cal-rod.

16. The beverage maker of claim 13, further comprising a controller configured to at least one of (1) cyclically supply power to, and shut off power to, the HLG and (2) adjust power supplied to the HLG.

17. The beverage maker of claim 16, further comprising a temperature sensor in operative communication with the controller, for directly or indirectly sensing the temperature of the liquid within the reservoir.

18. The beverage maker of claim 17, wherein the temperature sensor is located proximate the HLG inlet.

19. A beverage maker comprising:
a reservoir having a first inlet port for receiving a volume of liquid to be used for preparing a beverage and a first outlet port for discharging the liquid from the reservoir to a brew chamber to prepare the beverage;
a hot liquid generator (HLG) having an HLG inlet in fluid communication with a second outlet port of the reservoir and an HLG outlet in fluid communication with a second inlet port of the reservoir and a passageway therebetween; and
a valve in fluid communication with the reservoir, the valve being normally in an open position, permitting gas flow therethrough, and moveable into a closed position, preventing gas flow therethrough;
wherein liquid within the reservoir flows into the HLG passageway via the reservoir second outlet port and the HLG inlet, and powering of the HLG increases a temperature of at least a portion of the liquid within the HLG passageway and effectuates movement of the liquid in the HLG passageway back to the reservoir via the HLG outlet and the reservoir second inlet port, liquid being continuously recirculated between the reservoir and the HLG, without exiting from the reservoir first outlet port, at least until the valve is closed.

20. The beverage maker of claim 19, further comprising a pressure monitor in fluid communication with the reservoir for continuously monitoring pressure therein, and a pressure switch in electrical communication with the HLG, the pressure switch being actuatable by the pressure monitor between on and off configurations at a generally, predetermined threshold pressure within the reservoir, the pressure switch connecting a power supply to the HLG in one of the on and off configurations thereof, and the pressure switch disconnecting the power supply to the HLG in the other of the on and off configurations thereof.

21. The beverage maker of claim 20, wherein the pressure monitor comprises an expandable and contractible diaphragm, the diaphragm being expandable with increasing pressure within the reservoir and contractible with decreasing pressure within the reservoir, the diaphragm being configured to engage and actuate the pressure switch into one of the on and off configurations at substantially the threshold pressure within the reservoir and the diaphragm being configured to be disengaged from the pressure switch below the threshold pressure, thereby permitting the pressure switch to return to, or remain in, the other of the on and off configurations.

22. The beverage maker of claim 21, wherein the pressure switch is biased into the off configuration and is actuated to the on configuration when the pressure monitor determines that the pressure within the reservoir is substantially at or above the threshold pressure.
